(19) United States
(12) Patent Application Publication
(10) Pub. No.: US 2020/0302514 A1
(43) Pub. Date: Sep. 24, 2020

(54) AUTOMATIC SALE LISTING GENERATION

(71) Applicant: eBay Inc., San Jose, CA (US)

(72) Inventor: Binbin Shao, San Jose, CA (US)

(21) Appl. No.: 16/896,660

(22) Filed: Jun. 9, 2020

Related U.S. Application Data
(63) Continuation of application No. 14/927,898, filed on Oct. 30, 2015.

(51) Int. Cl. G06Q 30/06; G06Q 30/02

(52) U.S. Cl. CPC G06Q 30/0641; G06Q 30/0283; G06Q 30/06

(57) ABSTRACT

In various example embodiments, a system and method for automatically generating a listing database in an online marketplace are presented. The listing database can store resale information associated with a purchased item by a user. Additionally, an item database can have items currently listed on the online marketplace. Moreover, an application interface can access a purchase receipt having an item identifier that corresponds to the purchased item. Furthermore, a listing generator circuitry can access, from the item database, item information for the purchased item based on the item identifier. The listing generator circuitry can calculate a sale price for the purchased item based on the accessed item information, and receive an indication to generate a sale listing for the purchased item. Subsequently, in response to the received indication, the listing generator circuitry can generate the sale listing for the purchased item in the listing database.

### CROSS-REFERENCE TO RELATED APPLICATION

This application is a continuation of U.S. patent application Ser. No. 14/927,898, filed Oct. 30, 2015, which application and publication are incorporated herein by reference in its entirety.

### TECHNICAL FIELD

Embodiments of the present disclosure relate generally to sale listing generation and database generation. More particularly, but not by way of limitation, techniques to automatically generate a resale listing and database in an online marketplace based on purchased items by a user are described.

### BACKGROUND

Conventionally, a plurality of online marketplaces can provide listing services for items to be purchased. For example, a user can browse a website of the online marketplace and purchase items. The online marketplace can store a history of the purchased items for later retrieval by the user.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating an example embodiment of the listing generator of FIG. 1 including multiple modules forming at least a portion of the client-server system of FIG. 1.

FIGS. 3-5 are interface diagrams illustrating example user interfaces of an online marketplace with multiple display elements delivered to the user device by the listing generator, according to an example embodiment.

FIG. 6 is a block diagram illustrating an example data memory system including a number of data structures of the listing generator, in accordance with an example embodiment.

FIG. 7 is a flowchart illustrating an example method of automatically generating a sale listing for a purchased item in the listing database, in accordance with an example embodiment.

FIG. 8 is flowchart illustrating an example method of calculating the sale price in the generated sale listing of FIG. 7, in accordance with an example embodiment.

FIG. 9 is a block diagram illustrating components of a machine, according to some example embodiments, able to read instructions from a machine-readable medium and perform any one or more of the methodologies discussed herein.

### DETAILED DESCRIPTION

The description that follows includes systems, methods, techniques, instruction sequences, and computing machine program products that embody illustrative embodiments. In the following description, for the purposes of explanation, numerous specific details are set forth in order to provide an understanding of various embodiments of the subject matter discussed herein. It will be evident, however, to those skilled in the art, that embodiments of the inventive subject matter may be practiced without these specific details. In general, well-known instruction instances, protocols, structures, and techniques are not necessarily shown in detail.

In various example embodiments, an online marketplace includes an item database that includes all available items currently listed, previously listed, or both, on the online marketplace. In some instances, the online marketplace includes a listing database of items purchased by the user that the user wants to resale. The items purchased can be obtained from different online stores and physical stores. The listing database can enable the user to easily relist a purchased item for resale. Additionally, the user can easily keep track of the purchased items from different online marketplaces and physical stores using the listing database. Moreover, a sale price calculation module can assist the user by suggesting a sale price and the best time to resell the purchased item.

In some interfaces, the listing database can interface with multiple vendors and users, as well as multiple user devices of each user. For example, with the user's authorization, a vendor can send purchase receipts along with a user identifier corresponding to the user to the listing database.

Additionally, the purchase information corresponding to the purchased items can be accessed from the user's email using an application program interface (API). The email API can be installed on the user's email software to determine that an email is related to an online purchase, and automatically send purchase information from the email to the listing database. With regards to the email API, the user can opt-in to provide purchase information to the online marketplace.

Furthermore, the purchase information can be received from the user, such as the user forwarding the receipt to the listing database. For example, the user can forward the email receipt from the store to the listing database. Alternatively, the user can scan the physical receipt using a mobile device and send (e.g., email, Short Message Service (SMS)) the scanned receipt to the listing database. The listing database can allow the user to easily find an inventory of all the previously purchased items, regardless of where the item was purchased.

In some instances, the listing generator can calculate and suggest a sale price for reselling the purchased item. By calculating a resale price based on the recent sale history of the purchased item, the online marketplace can help users determine the optimal price for reselling the purchased item, without the user having to perform more research.

Moreover, a user can set up a price threshold for notification. For example, the online marketplace can notify the user when the calculated sale price of an item is above the price threshold. Based on the user's preferences, once the calculated price is above the price threshold, the purchased item can be automatically listed for resale. The price threshold can be a price value (e.g., $100) or a percentage of the purchase price (e.g., 80% or 120% of the purchase price).

In some instances, the listing generator can analyze a user's purchase history using the listing database and proactively notify the user to resell an item. The notification may be generated, provided, or both, based on seasonality, popularity, increased demand, or predicted demand for an item. For example, a notification can be presented to the user in August to resell a school-related item (e.g., a laptop) because the school year is starting. The notification can also include a price premium for selling the item in a certain time frame. The price premium, which can be calculated based on the price history of the purchased item, is the percentage price increase (e.g., 10% higher than normal sale price) over the average annual price for the purchased item.

The online marketplace can include a bi-directional, single sign-on interface to allow the user to log into any of these applications and websites using the same login information. The listing database can be stored in a centralized and secured repository so that users can access their purchased items using a plurality of user devices. Additionally or alternatively, users can share listing data or notifications with other people.

In various example embodiments, using the listing database, the user (e.g., consumer) can easily turn a purchase from any store into a sale listing on an online marketplace for resale. The online marketplace can simplify the reselling process by automatically creating a listing database and generating the sale listing for reselling a purchased item.

For example, the user can be more likely to sell items and sell more frequently, because the sale listing generation is simplified and the reselling experience for the user is improved compared to current implementations. Accordingly, the items listed for sale on the online marketplace can drastically increase based on the new generated sale listings, which in turn can increase revenue for the online marketplace. Moreover, by converting buyers into sellers, the online marketplace can grow its user base for sellers. Additionally, by converting buyers from other online marketplace to sellers on the online marketplace, the online marketplace can grow its user base.

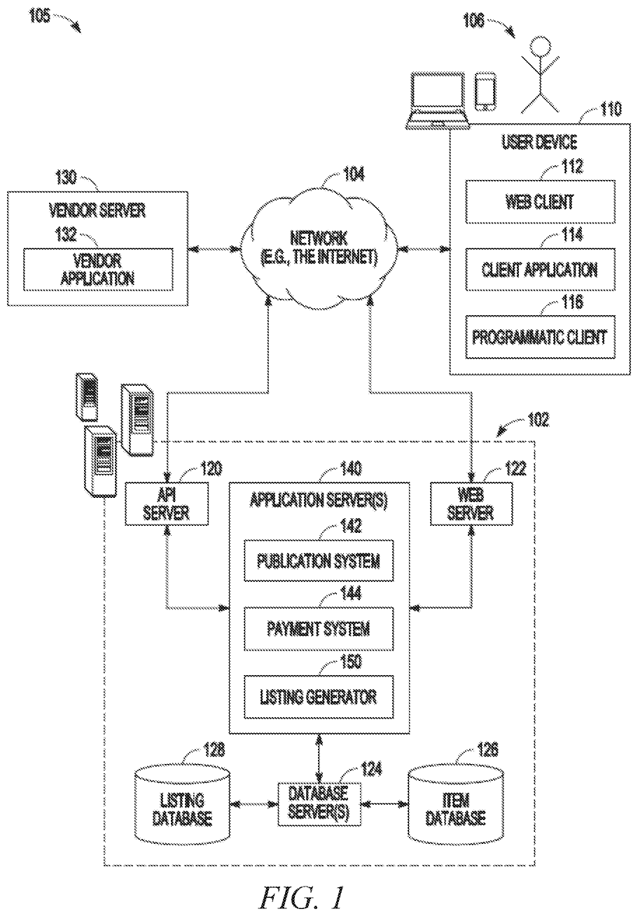

With reference to FIG. 1, an example embodiment of high-level client-server-based network architecture 100 is shown. A networked system 102, in the example form of a network-based marketplace or payment system, provides server-side functionality via a network 104 (e.g., the Internet or wide area network (WAN)) to one or more user device 110 (also referred to as a “client device”). FIG. 1 illustrates, for example, a web client 112, client application 114, and a programmatic client 116 executing on user device 110.

The user device 110 may comprise, but is not limited to, a mobile phone, desktop computer, laptop, portable digital assistant (PDA), smart phone, tablet, ultra-book, netbook, laptop, multi-processor system, microprocessor-based or programmable consumer electronic, game console, set-top box, or any other communication device that a user may utilize to access the networked system 102. In some embodiments, the user device 110 may comprise a display module to display information (e.g., in the form of user interfaces). In further example embodiments, the user device 110 may comprise one or more of a touch screen, accelerometer, gyroscope, camera, microphone, global positioning system (GPS) device, and so forth. The user device 110 may be a device that is used by a user to perform a transaction involving purchased items within the networked system 102. In one embodiment, the networked system 102 is a network-based marketplace that responds to requests for product listings, publishes publications comprising item listings of products available on the network-based marketplace, and manages payments for these marketplace transactions. One or more user 106 may be a person, a machine, or other means of interacting with user device 110. In embodiments, the user 106 is not part of the network architecture 100, but may interact with the network architecture 100 via user device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each user device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site (e.g., online marketplace) application is included in a given user device 110, then this application is configured to locally provide the user interface and at least some of the functionalities with the application configured to communicate with the networked system 102, on an as-needed basis, for data or processing capabilities not locally available (e.g., access to a database of items available for sale, to authenticate a user, to verify a method of payment, etc.). Conversely, if the e-commerce site application is not included in the user device 110, the user device 110 may use its web browser to access the e-commerce site (or a variant thereof) hosted on the networked system 102.

One or more users 106 may be a person, a machine, or other means of interacting with the user device 110. In example embodiments, the user 106 is not part of the network architecture 100, but may interact with the network architecture 100 via the user device 110 or other means. For instance, the user 106 provides input (e.g., touch screen input or alphanumeric input) to the user device 110 and the input is communicated to the networked system 102 via the network 104. In this instance, the networked system 102, in response to receiving the input from the user 106, communicates information to the user device 110 via the network 104 to be presented to the user 106. In this way, the user 106 interacts with the networked system 102 using the user device 110.

An application program interface (API) server 120 and a web server 122 are coupled to, and provide programmatic and web interfaces respectively to, one or more application server 140. The application server 140 may host one or more publication system 142, payment system 144, and a listing generator 150, each of which may comprise one or more modules or applications and each of which may be embodied as hardware, software, firmware, or any combination thereof. The application server 140 is, in turn, shown to be coupled to one or more database server 124 that facilitates access to information storage repositories, item database 126 or listing database 128. In an example embodiment, the listing database 128 can be a storage device that stores information to be posted (e.g., publications or listings) to the publication system 142. The listing database 128 may also store purchased items in accordance with example embodiments.

Additionally, a vendor application 132, executing on one or more vendor server 130, is shown as having programmatic access to the networked system 102 via the programmatic interface provided by the API server 120. For example, the vendor application 132, utilizing information retrieved from the networked system 102, supports one or more features or functions on a website hosted by the vendor. The vendor website, for example, provides one or more promotional, marketplace, or payment functions that are supported by the relevant applications of the networked system 102.

The publication system 142 may provide a number of publication functions and services to a user 106 that accesses the networked system 102. The payment system 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment system 144 may form part of the publication system 142.

The listing generator 150 provides functionality operable to perform various listing generation services using the purchase information. For example, the listing generator 150 may receive a purchase receipt of a purchased item and automatically generate a new sale listing for reselling the purchased item. Some of the information for the new listing can be obtained from the listing database 128, the item database, or the vendor server 130.

Moreover, one or more user 106 can register respective user accounts with the listing generator 150. Furthermore, a user 106 can access the user account with one or more devices, such as the user device 110, to access the user's inventory list of items for resale. In this way, the listing generator 150 provides centralized account data that is accessible by multiple user devices of the user 106, should the user use multiple devices. Additionally or alternatively, the listing generator 150 links the user's 106 activities on one device with the multiple devices of the user 106.

In some instances, the listing generator 150 receives user input that specifies an indication to generate a sale listing for the purchased item. The user input can include a minimum threshold price to resell the purchased item. Additionally, the listing generator 150 can provide notification services corresponding to events. For example, a notification attribute (e.g., based on user preference in a user profile) can trigger a notification to be sent to the user 106 when the calculated sale price is above the threshold price received from the user. Accordingly, the listing generator 150 monitors for notification events specified by the notification attribute. In response to detecting a notification event, the listing generator 150 provides to the user devices 110 linked to the user 106 a notification message.

In example embodiments, the notification message includes a textual, graphical, or audible message that provides a notice to the user 106 to confirm the listing of the purchased item on the online marketplace.

Further, while the client-server-based network architecture 100 shown in FIG. 1 employs a client-server architecture, the present subject matter is of course not limited to such an architecture, and could equally well find application in a distributed, or peer-to-peer, architecture system, for example. Publication system 142, payment system 144, or listing generator 150 could also be implemented as standalone software programs, which do not necessarily have networking capabilities. For example, the listing generator 150 can generate a sale listing without access to the application server, when the listing generator doesn't have network capabilities.

The web client 112 may access the listing generator 150 via the web interface supported by the web server 122. Similarly, the programmatic client 116 accesses the various services and functions provided by the listing generator 150 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

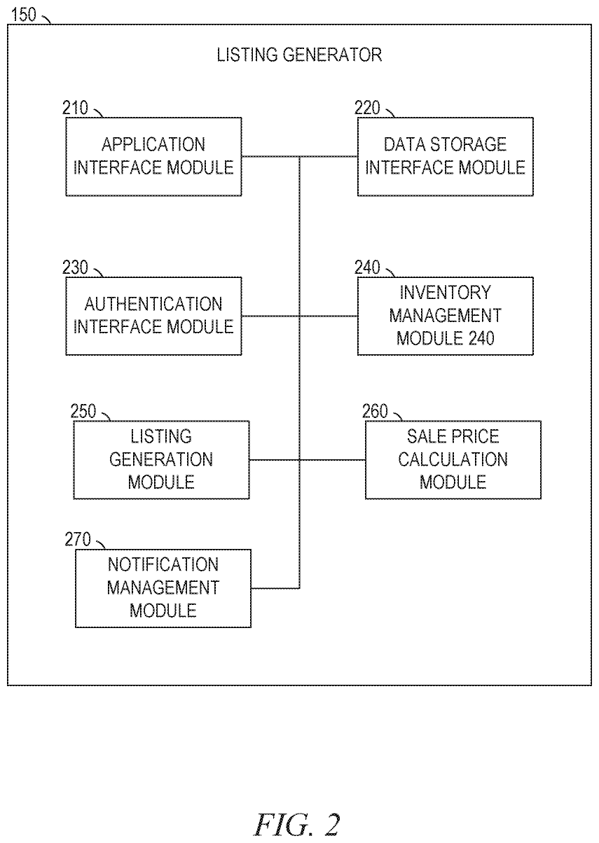

FIG. 2 is a block diagram illustrating an example embodiment of the listing generator 150 of FIG. 1 including multiple modules forming at least a portion of the network architecture 100 of FIG. 1. The modules 210-270 of the illustrated listing generator 150 include an application interface module 210, a data storage interface module 220, an authentication interface module 230, an inventory management module 240, a listing generation module 250, a sale price calculation module 260, and a notification management module 270. In some embodiments, the components of the listing generator 150 are included in the application server 140 of FIG. 1. However, it will be appreciated that in alternative embodiments, one or more components of the listing generator 150 described below are included, additionally or alternatively, in other devices, such as one or more of the user device 110 or the vendor server 130 of FIG. 1. It will also be appreciated that the listing generator 150 is deployed in systems other than online marketplaces.

The modules 210-270 of the listing generator 150 are hosted on dedicated or shared server machines that are communicatively coupled to enable communications between server machines. One or more of the modules 210-270 are deployed in one or more datacenters. Each of the modules 210-270 is communicatively coupled to the other modules 210-270 and to various data sources, so as to allow information to be passed between the modules 210-270 of the listing generator 150 or so as to allow the modules 210-270 to share and access common data.

The application interface module 210 is a hardware-implemented module that facilitates communication of data between the listing generator 150 and the user device 110, the vendor server 130, and other devices connected to the network 104. In particular, the application interface module 210 provides a user-facing graphical user interface (GUI) for interfacing with one or more user devices 110 and a vendor-facing GUI for interfacing with one or more vendor server 130, thus providing a bi-directional interface. For example, the application interface module 210 interfaces with the API server 120 to provide a programmatic interface to the vendor application 132 or to provide a web interface to the vendor application 132. As such, the application interface module 210 facilitates the providing of functions, webpages, data, code, or the like web resources between the listing generator 150 and the vendor application.

In operation, the listing generator 150 receives data from the one or more user devices 110, e.g., via the application interface module 210. The received data from the user devices 110 correspond to a number of inputs or requests related to, for example, purchase receipts; authentication; creating or editing user accounts; adding, removing, or editing the listing database 128; or sharing data (e.g., sharing selected items or notifications), as described below in greater detail.

The data storage interface module 220 is a hardware-implemented module that facilitates accessing data for the listing generator 150. In an example embodiment, the data storage interface module 220 interfaces with the listing database 128 and item database 126 of FIG. 1 to access one or more user accounts, vendor accounts, previously purchased items, or purchased items listed for resale.

The authentication interface module 230 is a hardware-implemented module that facilitates authenticating and authorizing devices that are communicatively coupled with the listing generator 150. In operation, the authentication interface module 230 receives authentication requests from a number of devices, such as, but not limited to, the user device 110 and the vendor server 130 of FIG. 1. In example embodiments, an authentication request is a data communication that is indicative of a request for authentication and includes authentication data. For example, authentication data includes identifier data (e.g., a user or vendor identifier) and credential (e.g., password) data.

In example embodiments, the authentication interface module 230 facilitates single-sign-on functionality. For example, the authentication interface module 230 receives authentication data from the user 106. The authentication data supplied by the user 106 is then used by the authentication interface module 230 to support the authentication of the user 106 to one or more vendor servers 130.

The authentication interface module 230 grants access to listing services provided by the listing generator 150. In example embodiments, the access to the listing database 128 can be restricted access to protect privacy. For example, the authentication interface module 230 grants the user device 110 access to a user account linked to the authentication data provided by the user device 110, and denies access to user accounts not linked to the authentication data provided by the user device 110.

The authentication interface module 230 can protect the privacy of the users and vendors. For example, in example embodiments, the authentication interface module 230 presents to a user a privacy setting that is selected to prevent the listing database 128 from being shared with other users or vendors without the user's permission. Additionally or alternatively, the authentication interface module 230 presents to the vendors a privacy setting that is selected to prevent data related to their vendor-item lists from being shared with other vendors.

The inventory management module 240 is a hardware-implemented module that facilitates maintaining the listing database 128. As previously mentioned, the listing database 128 includes the inventory list of purchased items designated for resale of the user. In operation, the inventory management module 240 can receive a number of requests from users. For example, the inventory management module 240 receives add-item, remove-item, edit-item, share-item, and the like requests from users.

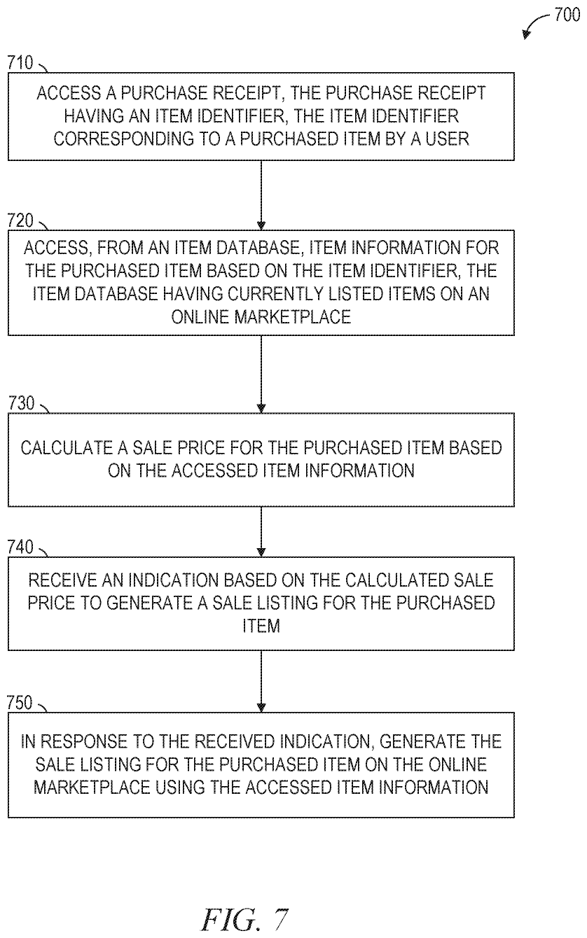

The listing generation module 250 is a hardware-implemented module that facilitates the automatic generation of a listing on the online marketplace. Based on an indication to list the purchased item, the listing generation module 250 can access from the item database 126 item information for the purchased item. In response to the received indication, the listing generation module 250 can generate the sale listing for the purchased item on the online marketplace using the accessed item information. FIG. 7 further describes actions performed by the listing generation module 250.

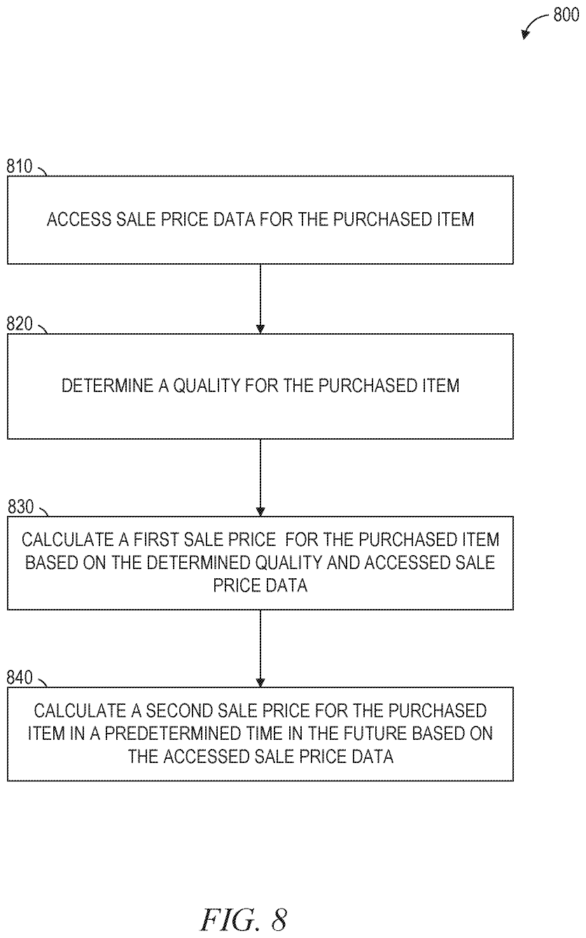

The sale price calculation module 260 is a hardware-implemented module that calculates a sale price for reselling the purchased item. The sale price is calculated based on historical sale price data and current sale price data, as further described in FIG. 8.

The notification management module 270 is a hardware-implemented module that facilitates providing users notifications related to their respective listing database 128. In operation, notification management module 270 monitors for notification events related to items of the listing database 128. Notification events trigger the notification management module 270 to provide notification messages to the users.

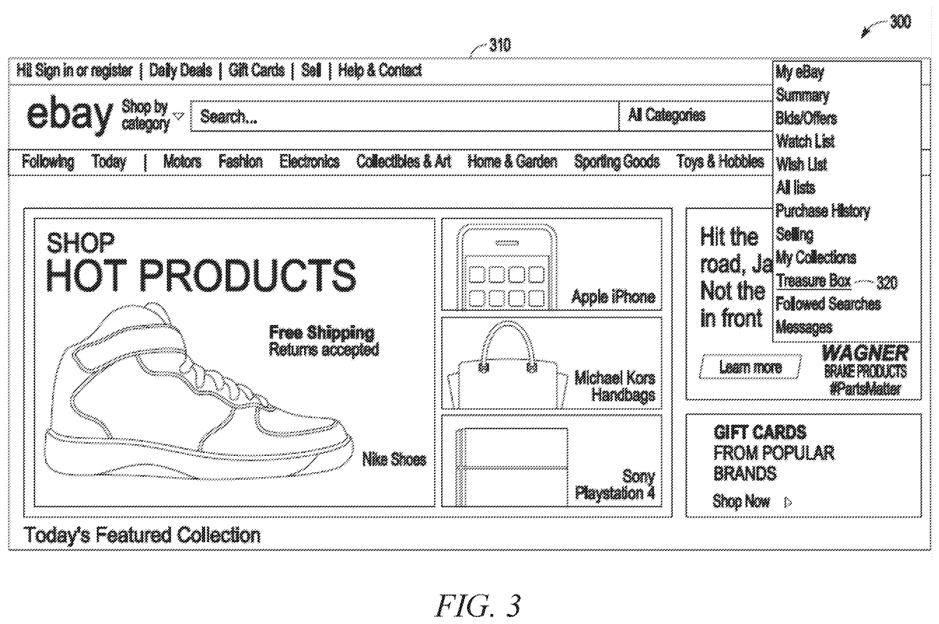

FIGS. 3-5 are interface diagrams illustrating example user interfaces 300, 400, and 500 of the online marketplace with multiple display elements delivered to the user device 110 by the listing generator 150, according to an example embodiment. As used herein, the listing generator 150 can have access to web resources that correspond to data or code being delivered to the user device 110 over the network 104 to render a webpage, or to be processed and rendered by a software application executing on the user device 110.

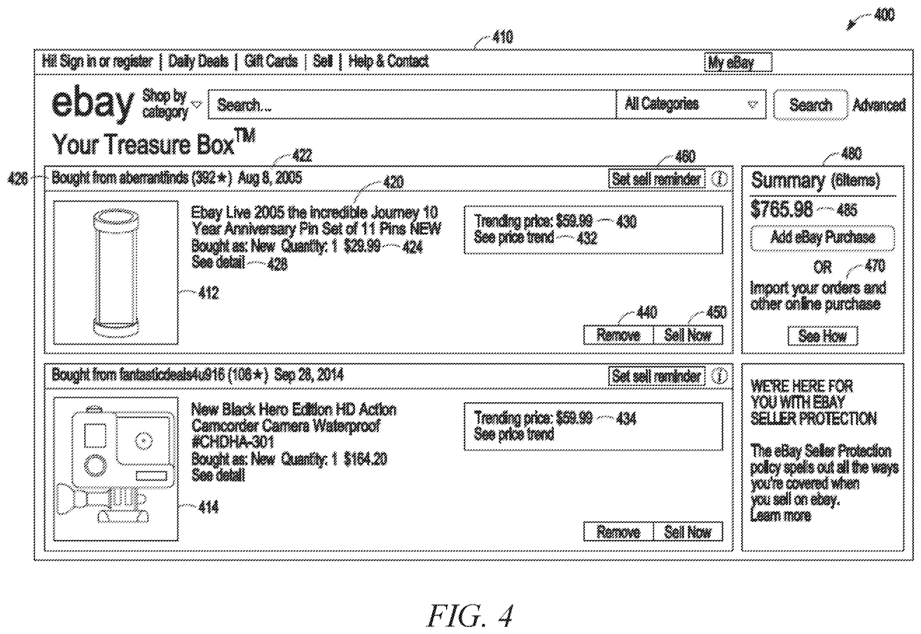

FIG. 3 is an interface diagram illustrating a user interface 300 including the user device 110 rendering a home screen 310 of the online marketplace providing listing services. In an example embodiment, the home screen 310 corresponds to a display of the online marketplace interfaced with the listing generator 150. The home screen 310 can be presented to the user in response to a successful authentication process. User input received by the home screen 310 from the user is transmitted to the listing generator 150 to present the listing database interface, as shown in FIG. 4.

The home screen 310 includes a number of control elements that are user-selectable to access features or display information of the listing generator 150. For example, the listing database interface button 320 (referred to as the “Treasure Box” in the example) can be selected by the user to access a user interface displaying listing information regarding the user's listing database 128. The listing information is displayed in a variety of formats, such as a list of previously purchased items. The listing database interface includes or refers to one or more of the purchased items.

User input received to select a control element (e.g., listing database interface button 320) can be transmitted by the user device 110 to the listing generator 150 over the network 104.

FIG. 4 is an interface diagram illustrating a user interface 400 including the user device 110 rendering a listing database interface 410 of the online marketplace. In an example embodiment, the listing database interface 410 corresponds to a display of items in the listing database 128 using the listing generator 150. The listing generator 150 provides data to the user device 110 to render the listing database interface 410 in response to the listing generator 150 receiving an indication that the user selected the listing database interface button 320 of FIG. 3. User input received by the listing database interface 410 from the user is transmitted to the listing generator 150.

The listing database interface 410 includes purchase information about a first purchased item 412 in the listing database 128. The purchase information can include an item description 420, a purchase date 422, a purchase price 424, a vendor 426, and more details 428 about the first purchased item 412. In some instances, the purchase information can be determined from the purchase receipt. Additionally the purchase information can include an item identifier. The item identifier can include, but not limited to, the item description 420, a barcode corresponding to the purchased item, or a stock keeping unit (SKU) identification.

Additionally, the listing database interface 410 can include a presentation of additionally purchased items in the listing database 128, such as a second purchased item 414. The second purchased item 414 can include purchase information similar to the first purchased item 412.

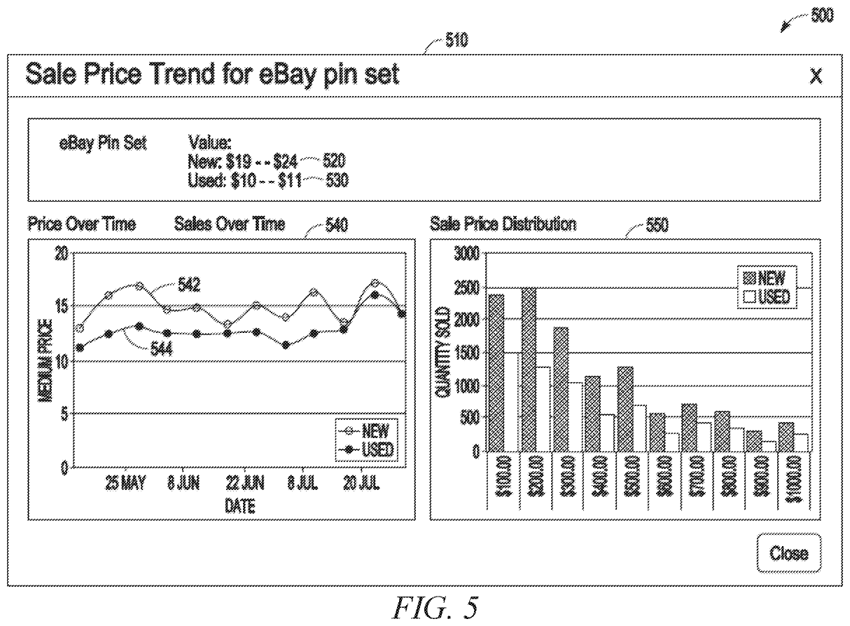

Moreover, the listing generator 150 can calculate a first sale price 430 for the first purchased item 412, and a second sale price 434 for the second purchased item 414 based on sale price data. In some instances, a user can also select the price trend button 432 to be presented the current price trends for the first purchased item 412, as illustrated in FIG. 5.

The listing database interface 410 can also include a remove button 440 to remove the purchased item from the listing database 128. Additionally, a sell now button 450 to resell the purchased item on the online marketplace. For example, the first purchased item 412 can be listed for resale using the first sale price 430 or a threshold price set by the user.

Furthermore, the listing database interface 410 can include other interface buttons, such as a reminder button 460 to set a sell reminder at a later date or an import button 470 to import other purchased items. For example, using the reminder button 460, reminders can be set for notifying the user to sell the purchased item. The user can also import other purchased items using the import button. The user can import purchase information using an email API, forwarding the purchase receipt via email, scanning the purchase receipt, or scanning the barcode of the purchased item. Additionally, the listing database interface 410 can also present a summary box 480 that includes the total value 485 of the purchased items in the listing database 128.

In example embodiments, the interface buttons can be selected by the user to access more information about the listing database 128 or to perform an action related to a purchased item in the listing database 128.

In some instances, the information from listing database 128 presented in the listing database interface 410 can be shared to group members of the user's social network. The group members can be formed based on a social network or a social graph relationship structure. In some instances, a user can select which members of the group receive the sale listing generated in FIG. 7.

FIG. 5 is an interface diagram illustrating a user interface 500 including the user device 110 rendering a sale price interface 510 for a purchased item. The listing generator 150 provides data to the user device 110 to render the sale price interface 510 in response to the listing generator 150 receiving an indication that the user selected the price trend button 432 (e.g., “See price trend”) of FIG. 4.

In an example embodiment, the sale price interface 510 corresponds to a display of a price for a purchased item calculated by the listing generator 150. FIG. 8 provides an exemplary method for calculating the sale price. User input received by the sale price interface 510 from the user is transmitted to the listing generator 150.

The sale price interface 510 includes a number of calculated prices based on historical price data for similar items to the purchased item. Similar items can be other specimens of the same product. For example, the sale price interface 510 can include a first estimated price range 520 when the purchased item is new, and a second estimated price range 530 when the purchased item is used.

Additionally, the sale price interface 510 can include a price trend graph 540 of recent sales for similar items to the purchased item over a predetermined amount of time. The price trend graph can include the sale history for a ‘new’ purchased item 542 and a ‘used’ purchased item 544.

Furthermore, the sale price interface 510 can include a sale price distribution graph 550 for the purchased item. The sale price distribution can include the number of items sold that are similar to the purchased item based on a price range.

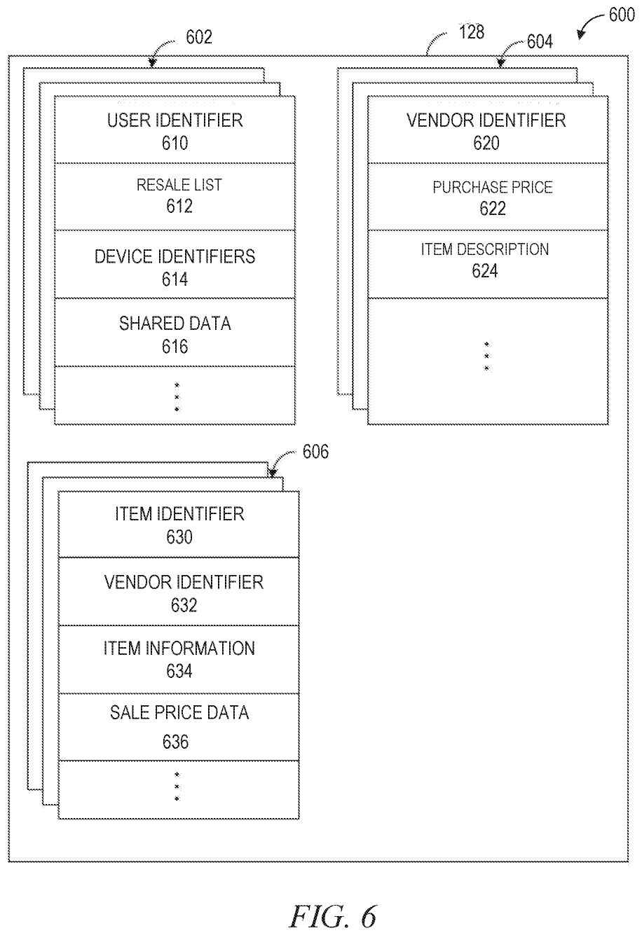

FIG. 6 is a block diagram illustrating an example data memory system 600 including a number of data structures of the listing database 128 and the item database 126, in accordance with an example embodiment. The data memory system 600 includes user accounts 602, vendor accounts 604, and an item database 606. The item database 606 is an example of the item database 126 in FIG. 1. In some instances, the vendor accounts 604 can be included in the item database 126 of FIG. 1. In an example embodiment, the user accounts 602 are stored in the listing database 128 of FIG. 1. It will be appreciated that the data of the data memory system 600 are stored together or separately in a number of data storage devices by one or more components of the client-server-based network architecture 100. The data storage interface module 220 (FIG. 2) of the listing generator 150 accesses the data memory system 600.

Respective user accounts 602 includes a user identifier data field 610, a resale list 612, a device identifiers data field 614, and a shared data field 616. The user identifier data field 610 includes data that link a user to a particular one of the user accounts 602. Furthermore, the user identifier data field 610 includes credential data (e.g., passwords, token-based identifier, or biometric data) that are used by the listing generator 150 to process authentication requests and verify the identity of the user of the user device 110. The resale list 612 includes (or a reference to) the purchased item that the user 106 wants to resell, which will be described in greater detail below. The device identifiers data field 614 includes device identifiers of user devices (e.g., user device 110) linked to the corresponding user. In an example embodiment, the device identifiers include data that is usable by the listing generator 150 to address the corresponding user devices 110 over the network 104.

The shared data field 616 includes data that indicates sharing privileges of the registered user and other registered users. For example, the shared data field 616 includes data that indicates that the registered user is sharing items in the resale list 612 with another registered user.

Respective vendor accounts 604 includes a vendor identifier data field 620, a purchase price 622, and an item description 624. The vendor identifier data field 620 can include purchase data for a purchased item from the vendor associated with the vendor accounts 604. The purchase data can include the purchase price 622, the item description 624, the purchase date, and other relevant information for reselling the purchased item. Furthermore, the vendor accounts 604 are accessed by the listing generator 150 to determine purchase information and item information about the purchased item. Moreover, the vendor identifier data field 620 includes authentication data that are used by the listing generator 150 to process authentication requests by vendors and verify the identity of the user of the vendor server(s) 130.

The item database 606 includes item identifier data 630, vendor identifier data 632, item information data 634, and sale price data 636. The item identifier data 630 includes data that are used to identify the purchased item in the online marketplace. The vendor identifier data 632 includes data that are used to identify a particular vendor in the online marketplace. Accordingly, in example embodiments, the item identifier data 630 and the vendor identifier data 632 are used together to uniquely identify the purchased item (e.g., an item description 420) and the seller (e.g., vendor 426). For example, the item database 606 can be accessed by the listing generator 150 to determine purchase information and item information about the purchased item, as described at block 720 of FIG. 7.

The item information data 634 includes data that is indicative of one or more characteristics or attributes of the item identified by the item identifier data field 630 and the vendor identifier data field 632. Examples of characteristics or attributes include an image, quantity, size, item type, price, sales, discounts, offers, or the like data to describe the purchased item.

The sale price data 636 includes price data for the purchased item sold on the online marketplace. The price data can include sale price information over a predetermined amount of time, such as in the past twelve months. The list generator 150, using the sale price calculation module 260, can use the sale price data 636 to generate the price trend graph 540 and the sale price distribution graph 550 of FIG. 5. As later described in another example, the sale price data 636 is used in block 730 of FIG. 7 and in method 800 of FIG. 8 to calculate the sale price for a purchased item.

FIG. 7 is a flowchart illustrating an example method 700 of automatically generating a sale listing for a purchased item, in accordance with an example embodiment. In this example, the method 700 includes operations such as receiving a purchase receipt (block 710), accessing the item database (block 720), calculating a sale price (block 730), receiving an indication to generate a sale listing (block 740), and generating a sale listing in the listing database (block 750). The example method 700 will be described below, by way of explanation, as being performed by certain modules. It will be appreciated, however, that the operations of the example method 700 can be performed in any suitable order by any number of the modules shown in FIG. 2.

In an example embodiment, the method 700 starts at block 710, in which the application interface module 210 receives a purchase receipt from a user device, such as user device 110 of FIG. 1. Alternatively, the purchase receipt can be receive from the vendor server 130, or another device connected to the network 104.

At block 710, the application interface module 210 can access (e.g., receive) a purchase receipt from user device 110. For example, the purchase receipt can be transmitted by user device 110 using the email API, by the user 106 forwarding an email with the purchase receipt, by the vendor server 130 sending the purchase information from the purchase receipt, or by the user 106 scanning and sending the physical receipt.

The purchase receipt can have an item identifier. For example, the item identifier can be the item identifier 630, such as a SKU number or barcode. The item identifier can correspond to an item purchased by user 106. The item identifier can be added to the resale list 612 (FIG. 6), the listing database interface 410 (FIG. 4), or the inventory database 128 for resale purposes. Furthermore, the inventory management module 240 uses the user identifier, vendor identifier, or item identifier of the purchase receipt to identify and select the user account 602 and the vendor account 604 for the purchased item. For example, the vendor account 604 can include warranty information for the purchased item that can be transferred to the next buyer.

In some instances, the purchase receipt can include a user identifier and authentication data. The authentication interface module 230 can authenticate the user based on the user credentials (e.g., username and password). The authentication can authorize access to listing database 128, listing database interface 410, and so on. In example embodiments, the user device 110 renders a user interface for receiving authentication data from the user 106 and initiating the authentication process. The listing generator 150 receives authentication data from the user device 110 via the API server 120 (e.g., where the user device 110 executes an application-based program supporting listing services) or via the web server 122 (e.g., where the user device 110 displays a webpage supporting listing services of the listing generator 150).

In some instances, the purchase receipt can include a device identifier, such as device identifier 614. The listing generator 150 can determine, using the device identifier 614, a plurality of connected devices linked the user. In some instances, the user associated with the purchase can be determined based on the device identifier 614.

At block 720, the data storage interface module 220 can access, from an item database, item information for the purchased item based on the item identifier. The item information can be sale information and product information of currently listed items on the online marketplace that are similar (e.g., other specimens of the same product) to the purchased item. For example, the item identifier 630 can be used by the listing generator 150 to access the item database 126, such as item database 606. The item database 606 can include vendor identifier 632, obtain item information 634, sale price data 636 for a specific item identifier 630. The item identifier 630 can be received at block 710 with the purchase receipt.

Additionally, the purchase receipt can include other purchase information, such as a vendor, a purchase price, a date of purchase, and other information associated with the purchase. For example, the data storage interface module 220 can use vendor information from the purchase receipt to determine a vendor and access the vendor accounts 604 for additional information. In some instances, by accessing the vendor accounts, the data storage interface module 220 can obtain purchase price 622, item description 624, and warranty information corresponding to the purchased item.

At block 730, the listing generator 150 using the sale price calculation module 260 can calculate a sale price for the purchased item based on the item information accessed at block 720. For example, the sale price calculation module 260 (FIG. 2) can calculate a sale price for the purchased item based on sale price data 636 accessed at block 720. Method 800 in FIG. 8 further describes techniques for calculating and presenting a sale price for the purchased item.

In some instances, to improve the sale through rate of the purchased items, the online marketplace can access several databases (e.g., item database 126, or listing database 128) for the sales history of the purchased item, the supply of the purchased item, and the demand of the purchased item.

For example, based on the sale history of the purchased item, the listing generator 150 can determine the conversion rate (e.g., likelihood of reselling) of the purchased item. Based on supply and demand of the purchased item in the online marketplace, the listing generator 150 can calculate the sale price and determine the timing for listing the purchased item. The supply of the purchased item can be determined based on the current inventory listed on the online marketplace. The demand of the purchased item can be determined based on the online marketplace users' search and purchase attempts. The purchase attempts can include a user indication to ‘watch’ or ‘follow’ an item, or the user placing a bid or offer to purchase the item.

In some instances, the listing generator 150 can determine a date of purchase from the received purchase receipt. For example, the purchase receipt can include a purchase date for the item. Additionally, the sale price calculation module 260 can determine a quality for the purchased item based on the determined date of purchase. For example, the determined quality can be based on the purchase date and item information 634 accessed at block 720. Subsequently, the sale price calculation module 260 can calculate the sale price based on the determination at block 730 and the determined quality for the purchased item.

At block 740, the listing generator 150 can receive an indication based on the calculated sale price to generate a sale listing for the purchased item. In some instances, the indication is a user input indicative of confirmation to generate the sale listing for the purchased item.

In another example, block 740 of the method 700 further includes the application interface module 210 receiving a user input corresponding to a threshold price for listing the purchased item. In this example, the indication to generate the sale listing can occur when the threshold price is above the calculated sale price. Additionally, the notification management module 270 can notify the user 106 that a sale listing is being generated and being automatically posted on the online marketplace.

In yet another example, block 740 of the method 700 further includes the application module 210 receiving a user input corresponding to a threshold price for listing the purchased item. In this example, the notification management module 270 can send a notification to the user 106 that the calculated sale price is above the threshold price, and the indication is a user confirmation to generate the sale listing for the purchased item based on the notification.

At block 750, the listing generator 150, in response to the received indication at block 740, can generate the sale listing for the purchased item on the online marketplace using the accessed item information. For example, the listing generation module 250 can generate a new sale listing to post on the online marketplace based on information obtained from blocks 710-740. Additionally, the listing database 128 can be updated to include the sale listing generated at block 730.

In some instances, the listing generator 150 can notify the user of the sale listing generated at block 750. The notification message can be, but is not limited to, a text message, a phone call, an email, and other types of messages. Additionally, the listing generator 150 can present, on a display of user device 110, the sale listing generated at block 750.

In some instances, the listing generator 150 can access, using the user identifier 610, sharing privileges of the user. Sharing privileges of the user can include information that the user has permitted the listing generator to share with others. The user identifier 610 can be received with the purchase receipt at block 710. Additionally, the listing generator 150 can select a sharing user based on the sharing privileges of the user. A notification message can be presented on a device associated with the sharing user. The notification message can be a text message sent to the sharing user to inform the sharing user that the sale listing for the purchased item is listed on the online marketplace.

In some instances, the user 106 initiates an authentication process via a website or an application of the online marketplace. It will be appreciated that in example embodiments the user 106 generates authentication requests in a number of additional or alternative ways. For example, the online marketplace links the listing generator 150 such that when the user 106 requests to sign in for listing services, the online marketplace transfers the user 106 to the listing generator 150 for authentication. That is, in example embodiments, the listing generator 150 provides a webpage to the user 106 for authenticating the user 106 instead of the online marketplace of the vendor server 130. Thus, the listing generator 150 directly prompts the user 106 for authentication requests, receives authentication requests, processes authentication requests, and provides to the vendor server 130 the results (e.g., pass or fail) of the authentication. In another example, an application (e.g., a software application for a mobile device or a desktop computer) executed on the user device 110 provides a GUI to the user 106 for authenticating the user 106. The application corresponds to a software application dedicated to the online marketplace for providing direct access to the listing generator 150. The listing generator 150 receives authentication data from the application, processes the application data, and returns the results to the application.

FIG. 8 is a flowchart illustrating an example method 800 of calculating a sale price at block 730 of FIG. 7, in accordance with an example embodiment. Elements common to FIGS. 7 and 8 share common reference indicia, and only differences between the figures are described herein for the sake of brevity. The method 800 will be described below, by way of explanation, as being performed by certain modules. It will be appreciated, however, that the operations of the method 800 can be performed in any suitable order by any number of the modules shown in FIG. 2.

At block 810, the listing generator 150, using the data storage interface module 220, can access sale price data 636 for the purchased item. As previously mentioned, the sale price data 636 can include historical sale price information for the purchased item. For example, the sale price data 636 includes sale price information for the purchased item based on location of sale and quality of the item. The sale price data 636 can include sale price information for the past twelve months, or another timeframe. The timeframe can be predetermined by the listing generator 150, or selected by the user 106.

At block 820, the listing generator 150, using the inventory management module 240, can determine a quality for the purchased item. The quality can be a description of the purchased item's condition, such as “brand new,” “like new,” “very good,” “good,” or “acceptable.” For example, the listing generator 150 can determine a date of purchase from the received purchase receipt (e.g., received at block 710 of FIG. 7). Additionally, the listing generator 150 can determine a quality for the purchased item based on the determined date of purchase.

At block 830, the listing generator 150, using the sale price calculation module 260, can calculate a first sale price for the purchased item based on the determined quality and the accessed sale price data.

In some instances, the sale price can be calculated for a local market (e.g., within 25 mile radius of the seller) and a global market (e.g., for out-of-state resale, for international resale).

At block 840, the sale price calculation module 260 can calculate a second sale price for reselling the purchased item at a predetermined date in the future. In some instances, the second sale price can be higher than the first sale price. For example, the listing generator 150 can send a notification to the user 106 that the purchased item can sell for a premium price at a later date. For example, the premium price is higher than the current price.

In some instances, the notification management module 270 can generate a graph for the user based the calculated sale prices in method 800. Additionally, method 800 can further include the listing generator 150 determining historical sale prices for the purchased item based on the accessed item information. Furthermore, the listing generator 150 can present a graph of the historical sale prices for the purchased item. The generation of the graph can be performed by the application server 140 and an image of the generated graph can be sent to the user device 110.

In another example, the listing database 128 can include a total value for the items in the listing database. Continuing with the example, the listing generator 150 can determine that the purchased item is fit for resale based on the accessed item information. For example, items that are frequently resold (e.g., purses, jewelry, electronics) in the online marketplace can be categorized as fit for resale. Subsequently, the listing generator 150 can add the purchased item to the listing database 128 based on the determination that the purchased item is fit for resale. Additionally, the sale price calculation module 260 can calculate a total value for items in the listing database based on the calculated sale price. For example, the total value for the items can be updated by adding the calculated sale price for the purchased item once the purchased item is added to the listing database 128. Furthermore, the notification management module 270 can present, on a device display of a user, the items in the listing database and the calculated total value.

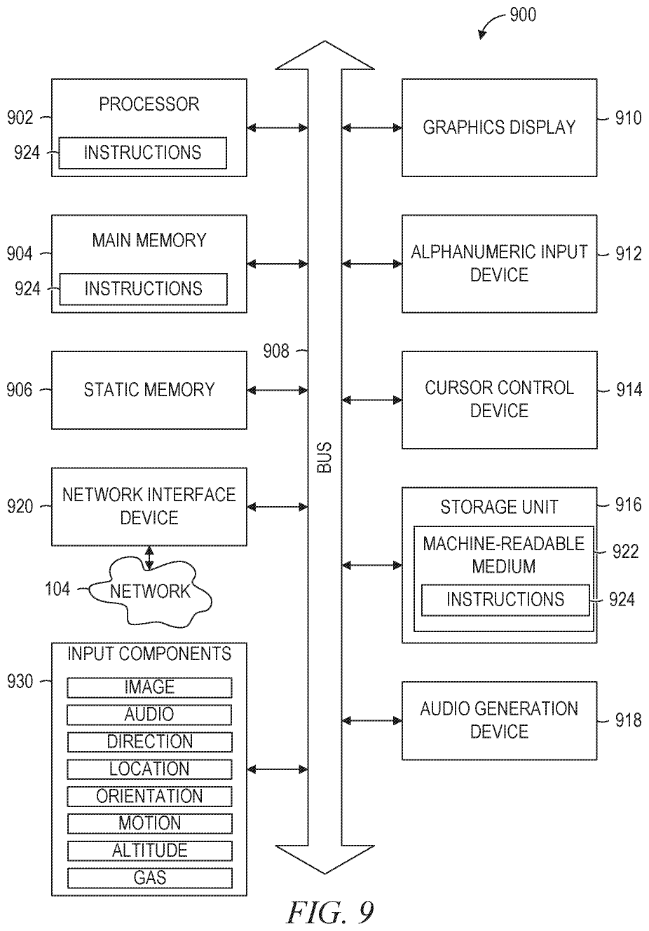

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part. The list generator 150 can be an example of the machine 900.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media 922 (e.g., tangible and non-transitory machine-readable media). The instructions 924 may be transmitted or received over the network 34 via the network interface device 920. For example, the network interface device 920 may communicate the instructions 924 using any one or more transfer protocols (e.g., hypertext transfer protocol (HTTP)).

The machine-readable medium 922 may include a magnetic or optical disk storage device, solid state storage devices such as flash memory, or other non-volatile memory device or devices. The computer-readable instructions 924 stored on the computer-readable storage medium 922 are in source code, assembly language code, object code, or another instruction format that is interpreted by one or more processors 902.

In some example embodiments, the machine 900 may be a portable computing device, such as a smartphone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 922 able to store data temporarily or permanently and may be taken to include, but not be limited to, random-access memory (RAM), read-only memory (ROM), buffer memory, flash memory, and cache memory. While the machine-readable medium 922 is shown, in an example embodiment, to be a single medium, the term “machine-readable medium” should be taken to include a single medium or multiple media (e.g., a centralized or distributed database, or associated caches) able to store the instructions 924. The term “machine-readable medium” shall also be taken to include any medium, or combination of multiple media, that is capable of storing the instructions 924 for execution by the machine 900, such that the instructions 924, when executed by one or more processors 902 of the machine 900 (e.g., the processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory, excluding signals) data repositories in the form of a solid-state memory, an optical medium, a magnetic medium, or any suitable combination thereof.

The foregoing description, for purposes of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the present disclosure and its practical applications, to thereby enable others skilled in the art to best utilize the present disclosure and various embodiments with various modifications as are suited to the particular use contemplated.

Throughout this specification, plural instances may implement components, operations, or structures described as a single instance. Although individual operations of one or more methods are illustrated and described as separate operations, one or more of the individual operations may be performed concurrently, and the operations can be performed in a different order than illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 922 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 902) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 902 or other programmable processor 902. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 902 configured by software to become a special-purpose processor, the general-purpose processor 902 may be configured as respectively different special-purpose processors (e.g., comprising different hardware modules) at different times. Software (e.g., a software module) may accordingly configure one or more processors 902, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions described herein. As used herein, “processor-implemented module” refers to a hardware module implemented using one or more processors 902.

Similarly, the methods described herein may be at least partially processor-implemented, a processor 902 being an example of hardware. For example, at least some of the operations of a method may be performed by one or more processors 902 or processor-implemented modules. As used herein, “processor-implemented module” refers to a hardware module in which the hardware includes one or more processors 902. Moreover, the one or more processors 902 may also operate to support performance of the relevant operations in a “cloud computing” environment or as a “software as a service” (SaaS). For example, at least some of the operations may be performed by a group of computers (as examples of machines including processors 902), with these operations being accessible via a network 104 (e.g., the Internet) and via one or more appropriate interfaces (e.g., an application program interface (API)).

The performance of certain operations may be distributed among the one or more processors 902, not only residing within a single machine, but deployed across a number of machines. In some example embodiments, the one or more processors 902 or processor-implemented modules may be located in a single geographic location (e.g., within a home environment, an office environment, or a server farm). In other example embodiments, the one or more processors 902 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the arts. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” such as “and/or,” unless specifically stated otherwise.

What is claimed is:

1. A method comprising:
performing operations for implementing a listing database interface for facilitating reselling of purchased items, the operations comprising:
accessing purchase receipt data from a vendor server associated with the purchased items, the purchase receipt data including item identifiers that correspond to the purchased items;
accessing, from an item database, item information for the purchased items based on the item identifiers, the item database having currently listed items on an online marketplace;
generating a listing of the purchased items for inclusion on the listing database interface, the listing including sale prices for the purchased items, the sale prices for the purchased items being calculated based on the accessed item information, the listing also including predicted future sale prices for the purchased items at a predetermined date in the future;
associating one or more user interface elements with the listing, each of the one or more user interface associated with an action of a plurality of actions, the plurality of actions including removing one of the purchased items from the listing, generating a sales listing for the one of the purchased items, and generating one or more reminders to generate the sales listing for the one of the purchased items at a predetermined date in the future;
communicating the listing and the one or more user interface elements to a client device for presentation in the listing database interface on the client device; and
based on a selection of one of the one or more user interface elements, performing the action associated with the user interface element.

2. The method of claim 1, further comprising:
determining a date of purchase from the accessed purchase receipt data;
determining a quality for the purchased item based on the determined date of purchase and the accessed item information; and
wherein the calculated sale price is further based on the determined quality for the purchased item.

3. The method of claim 1, wherein the purchase receipt data is accessed from an email of the user using an email application program interface.

4. The method of claim 1, further comprising:
receiving an image of a physical receipt, and wherein the purchase receipt data is accessed from the received image.

5. The method of claim 1, further comprising:
receiving, from the user, an email, and wherein the purchase receipt data is accessed from the received email.

6. The method of claim 1, further comprising:
determining historical sale prices for the purchased item based on the accessed item information;
generating a graph of the historical sale prices for the purchased item; and
presenting, on a device display of the user, the generated graph.

7. The method of claim 1, further comprising:
determining that the purchased item is fit for resale based on the accessed item information;
adding the purchased item to a listing database based on the determination that the purchased item is fit for resale;
calculating a total value for items in the listing database based on the calculated sale price; and
presenting, on a device display of the user, the items in the listing database and the calculated total value.

8. A non-transitory machine-readable storage medium comprising instructions that, when executed by one or more processors of a machine, cause the machine to perform operations for implementing a listing database interface for facilitating reselling of purchased items, the operations comprising:
accessing purchase receipt data from a vendor server associated with the purchased items, the purchase receipt data including item identifiers that correspond to the purchased items;
accessing, from an item database, item information for the purchased items based on the item identifiers, the item database having currently listed items on an online marketplace;
generating a listing of the purchased items for inclusion on the listing database interface, the listing including sale prices for the purchased items, the sale prices for the purchased items being calculated based on the accessed item information, the listing also including predicted future sale prices for the purchased items at a predetermined date in the future;
associating one or more user interface elements with the listing, each of the one or more user interface associated with an action of a plurality of actions, the plurality of actions including removing one of the purchased items from the listing, generating a sales listing for the one of the purchased items, and generating one or more reminders to generate the sales listing for the one of the purchased items at a predetermined date in the future;
communicating the listing and the one or more user interface elements to a client device for presentation in the listing database interface on the client device; and
based on a selection of one of the one or more user interface elements, performing the action associated with the user interface element.

9. The storage medium of claim 8, further comprising instructions that cause the machine to perform operations comprising:
determining a date of purchase from the accessed purchase receipt data;
determining a quality for the purchased item based on the determined date of purchase and the accessed item information; and
wherein the calculated sale price is further based on the determined quality for the purchased item.

10. The storage medium of claim 8, further comprising instructions that cause the machine to perform operations comprising:
determining that the purchased item is fit for resale based on the accessed item information;
adding the purchased item to a listing database based on the determination that the purchased item is fit for resale;
calculating a total value for items in the listing database based on the calculated sale price; and
presenting, on a device display of a user, the items in the listing database and the calculated total value.

11. A system comprising:
a listing database to store resale information associated with purchased items;
an item database having currently listed items on an online marketplace;
an application interface configured to access purchase receipt data from a vendor server associated with the purchased items, the purchase receipt data including item identifiers that correspond to the purchased items; and
a listing generator circuitry, having one or more processors, to perform operations for implementing a listing database interface for facilitating reselling of purchased items, the operations comprising:
accessing, from the item database, item information for the purchased item based on the item identifiers;
generating a listing of the purchased items for inclusion on the listing database interface, the listing including sale prices for the purchased item, the sale prices for the purchased items being calculated based on the accessed item information, the listing also including predicted future sale prices for the purchased items at a predetermined date in the future;
associating one or more user interface elements with the listing, each of the one or more user interface associated with an action of a plurality of actions, the plurality of actions including removing one of the purchased items from the listing, generating a sales listing for the one of the purchased items, and generating one or more reminders to generate the sales listing for the one of the purchased items at a predetermined date in the future;
communicating the listing and the one or more user interface elements to a client device for presentation in the listing database interface on the client device; and
based on a selection of one of the one or more user interface elements, performing the action associated with the user interface element.

12. The system of claim 11, wherein the listing generator circuitry is further configured to:
determine a date of purchase from the accessed purchase receipt data;
determine a quality for the purchased item based on the determined date of purchase and the accessed item information; and
wherein the calculated sale price is further based on the determined quality for the purchased item.
